(19) United States
(12) Patent Application Publication
(10) Pub. No.: US 2020/0277903 A1
(43) Pub. Date: Sep. 3, 2020

(54) CYLINDER DEACTIVATION SYSTEM AND CYLINDER DEACTIVATION METHOD

(71) Applicant: Honda Motor Co., Ltd., Tokyo (JP)

(72) Inventors: Yuki Yamada, Wako-shi (JP); Junpei Okuyama, Wako-shi (JP)

(21) Appl. No.: 16/800,683

(22) Filed: Feb. 25, 2020

(30) Foreign Application Priority Data
Feb. 28, 2019 (JP) 2019-035503
Jan. 6, 2020 (JP) 2020-000119

(51) Int. Cl. F02D 17/02; F02D 41/26; F02D 41/00

(52) U.S. Cl. CPC F02D 17/02; F02D 41/26; F02D 2200/1002; F02D 41/0085; F02D 2200/101; F02D 41/0087

(57) ABSTRACT

A cylinder deactivation system includes an internal combustion engine including a plurality of cylinders, a first catalyst device and a second catalyst device respectively disposed in exhaust passages of the first group cylinders and the second group cylinders, a fuel supply part configured to individually supply a fuel to each cylinder, and a microprocessor. The microprocessor outputs a mode switch instruction from a first mode in which a fuel supply to the cylinders is performed to a second mode in which the fuel supply to the cylinders is stopped, and when the mode switch instruction is output, control the fuel supply part so as to stop the fuel supply to the cylinders in stages. The microprocessor controls the fuel supply part so as to stop a fuel supply to the second group cylinders after a fuel supply to the first group cylinders is stop.

### CROSS-REFERENCE TO RELATED APPLICATION

This application is based upon and claims the benefit of priority from Japanese Patent Application No. 2019-035503 filed on Feb. 28, 2019 and Japanese Patent Application No. 2020-000119 filed on Jan. 6, 2020, the content of which is incorporated herein by reference.

### BACKGROUND OF THE INVENTION

### Field of the Invention

This invention relates to a cylinder deactivation system and a cylinder deactivation method for deactivating an operation of an internal combustion engine.

### Description of the Related Art

As this type of apparatus, there have been known apparatuses that when predetermined conditions are satisfied during deceleration of the vehicle, sequentially stop fuel injection to the multiple cylinders of an engine with time. Such an apparatus is described in, for example, Japanese Unexamined Patent Application Publication No. 2003-049684 (JP2003-049684A). The apparatus of JP2003-049684A sequentially stops fuel injection to the cylinders in accordance with the order of ignition of the cylinders.

However, if an apparatus that sequentially stops fuel injection to cylinders in accordance with the ignition order, such as JP2003-049684A, is disposed in a system in which catalyst devices for cleaning up emissions are disposed on multiple exhaust passages connected to an engine, the catalyst devices may not be able to sufficiently clean up emissions.

### SUMMARY OF THE INVENTION

A cylinder deactivation system includes an internal combustion engine including a plurality of cylinders having a plurality of first group cylinders belonging to a first group and a plurality of second group cylinders belonging to a second group, a first catalyst device and a second catalyst device respectively disposed in an exhaust passage of the first group and an exhaust passage of the second group, a fuel supply part configured to individually supply a fuel to each of the plurality of cylinders, and an electronic control unit having a microprocessor and a memory connected to the microprocessor. The microprocessor is configured to perform outputting a mode switch instruction from a first mode in which a fuel supply to the plurality of cylinders is performed to a second mode in which the fuel supply to the plurality of cylinders is stopped, and when the mode switch instruction is output, controlling the fuel supply part so as to stop the fuel supply to the plurality of cylinders in stages. The microprocessor is configured to perform the controlling including controlling the fuel supply part so as to stop a fuel supply to the plurality of second group cylinders after a fuel supply to the plurality of first group cylinders is stop.

### BRIEF DESCRIPTION OF THE DRAWINGS

The objects, features, and advantages of the present invention will become clearer from the following description of embodiments in relation to the attached drawings, in which:

FIG. 1 is a drawing showing a position of multiple cylinders of an engine to which a cylinder deactivation system according to an embodiment of the present invention is applied;

FIG. 2 is a drawing schematically showing a configuration of main components of an engine to which a cylinder deactivation system according to an embodiment of the present invention is applied;

FIG. 3 is a diagram showing an example of the operation as a comparative example;

FIG. 4 is a block diagram showing a configuration of main components of a cylinder deactivation system according to an embodiment of the present invention;

FIG. 5 is a diagram showing an example of characteristics set by the controller in FIG. 4;

FIG. 6 is a diagram showing an example of delay times of each cylinder calculated by the controller in FIG. 4;

FIG. 7 is a flowchart showing an example of a process performed by the controller in FIG. 4;

FIG. 8 is a diagram showing an example of the operation of a cylinder deactivation system according to an embodiment of the present invention; and

FIG. 9 is showing another example of characteristics set by the controller in FIG. 4.

### DETAILED DESCRIPTION OF THE INVENTION

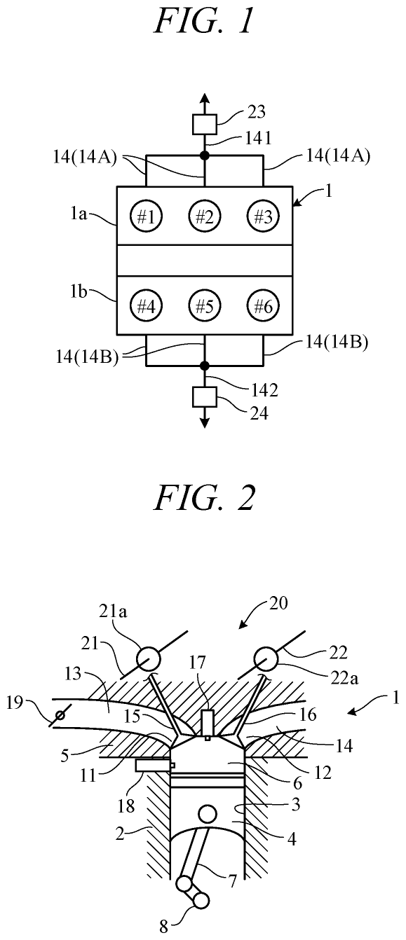

Now, an embodiment of the present invention will be described with reference to FIGS. 1 to 9. A cylinder deactivation system according to the embodiment of the present invention is applied to an engine that is a spark-ignition internal combustion engine having a fuel cut function of stopping fuel supply to multiple cylinders during decelerated travel or the like of the vehicle. For example, this engine is a V-6 engine where multiple cylinders are disposed in a V-shape in a side view and a pair of front and rear banks are formed and is also a four-cycle engine that undergoes four strokes of intake, expansion, compression and exhaust in one operation cycle. Note that the engine may be an engine where a pair of left and right banks are formed.

FIG. 1 is a drawing showing the position of multiple (six) cylinders [symbol] 1 to [symbol] 6 of an engine 1. The engine 1 includes three cylinders [symbol] 1 to [symbol] 3 belonging to a front side bank (front bank) 1a and three cylinders [symbol] 4 to [symbol] 6 belonging to a rear side bank (rear bank) 1b. Hereafter, the three cylinders [symbol] 1 to [symbol] 3 belonging to the front bank (first group) 1a may be referred to as the “front-bank cylinders (or first group cylinders),” and the three cylinders [symbol] 4 to [symbol] 6 belonging to the rear bank (second group) 1b as the “rear-bank cylinders (or second group cylinder).” The cylinders [symbol] 1 to [symbol] 6 have the same configuration.

FIG. 2 is a drawing schematically showing the configuration of main components of the engine 1. FIG. 2 shows the configuration of one of the cylinders [symbol] 1 to [symbol] 6. As shown in FIG. 2, the engine 1 includes a cylinder 3 formed in a cylinder block 2, a piston 4 disposed slidably in the cylinder 3, and a combustion chamber 6 formed between the piston 4 and a cylinder head 5. The piston 4 is coupled to a crankshaft 8 through a connecting rod 7. Reciprocation of the piston 4 along the inner wall of the cylinder 3 causes rotation of the crankshaft 8.

The cylinder head 5 is provided with an intake port 11 and an exhaust port 12. An intake passage 13 communicates with the combustion chamber 6 through the intake port 11, while an exhaust passage 14 communicates with the combustion chamber 6 through the exhaust port 12. The intake port 11 is opened and closed by an intake valve 15, and the exhaust port 12 is opened and closed by an exhaust valve 16. A throttle valve 19 is disposed on the intake passage 13 located at the upstream side of the intake valve 15. The throttle valve 19 consists of, for example, a butterfly valve. The throttle valve 19 controls the amount of intake air supplied to the combustion chamber 6. The intake valve 15 and exhaust valve 16 are open/close driven by a valve train 20.

An ignition plug 17 and a direct-injection injector 18 are mounted on the cylinder head 5 and cylinder block 2, respectively, so as to face the combustion chamber 6. The ignition plug 17 is disposed between the intake port 11 and exhaust port 12. The ignition plug 17 generates a spark by electrical energy to ignite a fuel-air mixture in the combustion chamber 6. The injector 18 is disposed adjacent to the intake valve 15. The injector 18 is driven by electrical energy and injects the fuel downward into the combustion chamber 6. Note that the injector 18 may be disposed otherwise and may be disposed, for example, near the ignition plug 17.

The valve train 20 includes an intake cam shaft 21 and an exhaust cam shaft 22. The intake cam shaft 21 is integrally provided with intake cams 21a corresponding to the respective cylinders 3. The exhaust cam shaft 22 is integrally provided with exhaust cams 22a corresponding to the cylinders 3. The intake cam shaft 21 and exhaust cam shaft 22 are coupled to the crankshaft 8 through timing belts (not shown) and rotate once each time the crankshaft 8 rotates twice. The intake valve 15 is opened and closed by rotation of the intake cam shaft 21 through an intake rocker arm (not shown) at a predetermined timing corresponding to the profile of the intake cam 21a. The exhaust valve 16 is opened and closed by rotation of the exhaust cam shaft 22 through an exhaust rocker arm (not shown) at a predetermined timing corresponding to the profile of the exhaust cam 22a.

The output torque of the engine 1, that is, the torque generated by rotation of the crankshaft 8 is inputted to a transmission (not shown). The transmission is a stepped transmission, which is able to change the speed ratio in stages so as to correspond to multiple shift positions (e.g., six positions). Note that the transmission may be a continuously variable transmission (CVT), which is able to change the speed ratio continuously. Rotation from the engine 1 is speed-changed by the transmission and then transmitted to the drive wheels. Thus, the vehicle travels.

As shown in FIG. 1, the exhaust passages 14 of the front-bank cylinders [symbol] 1 to [symbol] 3 are connected to a common exhaust passage 141, and the exhaust passages 14 of the rear-bank cylinders [symbol] 4 to [symbol] 6 are connected to a common exhaust passage 142. Note that the exhaust passages of the front-bank cylinders [symbol] 1 to [symbol] 3 and the exhaust passages of the rear-bank cylinders [symbol] 4 to [symbol] 6 may be represented by 14A and 14B, respectively, for distinction. Catalyst devices 23 and 24 for cleaning up emissions are disposed in the exhaust passages 141 and 142, respectively. The catalyst devices 23 and 24 are three-way catalysts having a function of eliminating and cleaning up HC, CO, and NOx included in emissions by oxidation and reduction and have the same configuration. The clean-up efficiency of the catalyst devices 23 and 24 is high when the air fuel ratio is the stoichiometric air fuel ratio. The clean-up efficiency of HC and CO is low in a fuel excess state (a rich state), and the clean-up efficiency of NOx is low in an air excess state (a lean state).

If, in the engine 1 thus configured, fuel supply from the injectors 18 to the cylinders [symbol] 1 to [symbol] 6 is simultaneously stopped (that is, fuel cut is performed simultaneously on the cylinders [symbol] 1 to [symbol] 6) when a predetermined fuel cut condition is satisfied, the engine output torque is suddenly reduced and shock to a driver of the vehicle is caused. To reduce such shock, it is conceivable that fuel cut will be performed on the cylinders on a cylinder-by-cylinder basis in a predetermined order with a lapse of time.

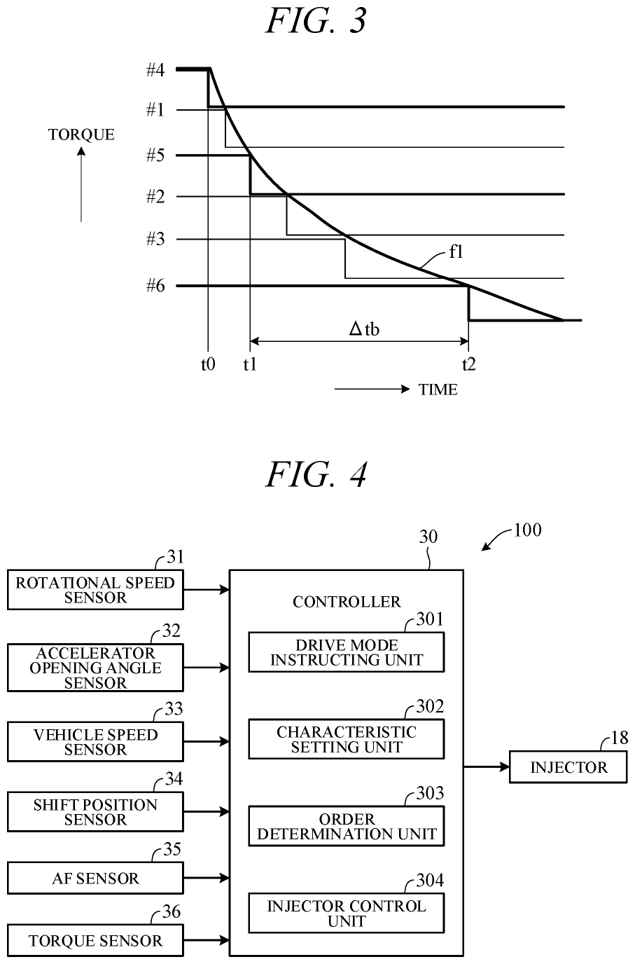

However, if fuel cut is performed on a cylinder-by-cylinder basis in a configuration in which the catalyst devices 23 and 24 are disposed so as to correspond to the front-bank cylinders [symbol] 1 to [symbol] 3 and the rear-bank cylinders [symbol] 4 to [symbol] 6, respectively, such as the present embodiment, the combustion time in a lean state may become longer. This may increase the amount of stored oxygen and thus make the reduction of NOx difficult, which may lead to emission deterioration. FIG. 3 is a diagram showing this problem and shows an example of the operation during fuel cut. In FIG. 3, the horizontal axis represents the time, and the vertical axis represents the engine output torque. A characteristic f1 set such that the torque is gradually reduced with time is a characteristic for determining the fuel cut timing (a fuel cut characteristic).

In FIG. 3, a fuel cut instruction is output and then fuel cut is performed in stages in the order of [symbol] 4→ [symbol] 1→ [symbol] 5→ [symbol] 2→ [symbol] 3→ [symbol] 6 (e.g., in the combustion order) from time point t0. For example, note the rear-bank cylinders [symbol] 4 to [symbol] 6 shown by thick lines in FIG. 3. In the period from time point t0 to time point t1, combustion is performed in the two cylinders and [symbol] 6 of the rear-bank cylinders [symbol] 4 to [symbol] 6 (two-cylinder combustion); in the period from time point t1 to time point t2, combustion is performed in the one cylinder [symbol] 6 thereof (one-cylinder combustion). For this reason, the rear-bank cylinders [symbol] 4 to [symbol] 6 as a whole become a lean state at time point t0 and later. Particularly, at time point t1, when one-cylinder combustion is started, and later, the level of leanness and thus the amount of oxygen stored in the catalyst device 24 are increased.

The lean-state allowable time, that is, the time in which the amount of stored oxygen is not saturated and the catalyst device 24 is able to exhibit NOx clean-up ability (leanness allowable time Δta) depends on the ability of the catalyst device 24. If the actual lean-state time (e.g., the one-cylinder combustion time Δtb) is longer than the leanness allowable time Δta, Nox is not cleaned up, leading to emission deterioration. To prevent such emission deterioration, the cylinder deactivation system according to the present embodiment is configured as follows.

FIG. 4 is a block diagram showing the configuration of main components of a cylinder deactivation system 100 according to the present embodiment. As shown in FIG. 4, the cylinder deactivation system 100 is formed centered on a controller 30 for controlling the engine. A rotational speed sensor 31, an accelerator opening angle sensor 32, a vehicle speed sensor 33, a shift position sensor 34, AF sensors 35, a torque sensor 36, the multiple injectors 18 disposed on the cylinders [symbol] 1 to [symbol] 6 (only one is shown in FIG. 4) are connected to the controller 30.

The rotational speed sensor 31 is a sensor that detects the engine rotational speed and consists of, for example, a crank angle sensor that is disposed on the crankshaft 8 and outputs a pulse signal in association with rotation of the crankshaft 8. The accelerator opening angle sensor 32 is disposed on the accelerator pedal (not shown) of the vehicle and detects the manipulated variable of the accelerator pedal (accelerator opening angle). The vehicle speed sensor 33 detects the vehicle speed. The shift position sensor 34 detects the current shift position of the transmission. The AF sensors 35 are disposed on the respective exhaust passages 14A and 14B and detect the emission air fuel ratio in the exhaust passages 14A and 14B. The torque sensor 36 is a sensor that detects the output torque of the engine 1 or a physical quantity having a correlation with the output torque and consists of, for example, an air-flow sensor that detects the amount of intake air of the engine 1. The output torque (estimated torque) of the engine 1 is obtained on the basis of the value detected by the torque sensor 36.

The controller 30 consists of an electronic control unit (ECU) and includes a computer including an arithmetic processing unit, such as a CPU, a storage unit, such as a ROM or RAM, and other peripheral circuits. The controller 30 includes a drive mode instructing unit 301 as instructing unit, a characteristic setting unit 302 as setting unit, an order determination unit 303, and an injector control unit 304 as functional elements.

The drive mode instructing unit 301 determines whether a predetermined fuel cut condition is satisfied, on the basis of signals from the rotational speed sensor 31, accelerator opening angle sensor 32 and vehicle speed sensor 33. If it determines that the fuel cut condition is satisfied, the drive mode instructing unit 301 outputs an instruction (mode switch instruction) to switch the drive mode from a normal mode in which fuel cut is not performed on the cylinders [symbol] 1 to [symbol] 6 to a stop mode in which fuel cut is performed thereon. Specifically, if, in a non-fuel cut state, the accelerator opening angle is equal to or smaller than a predetermined value; the engine rotational speed is equal to or greater than a predetermined value; and the vehicle speed is equal to or greater than a predetermined value, the drive mode instructing unit 301 determines that the fuel cut condition is satisfied. For example, during deceleration travel, the drive mode instructing unit 301 determines that the fuel cut condition is satisfied.

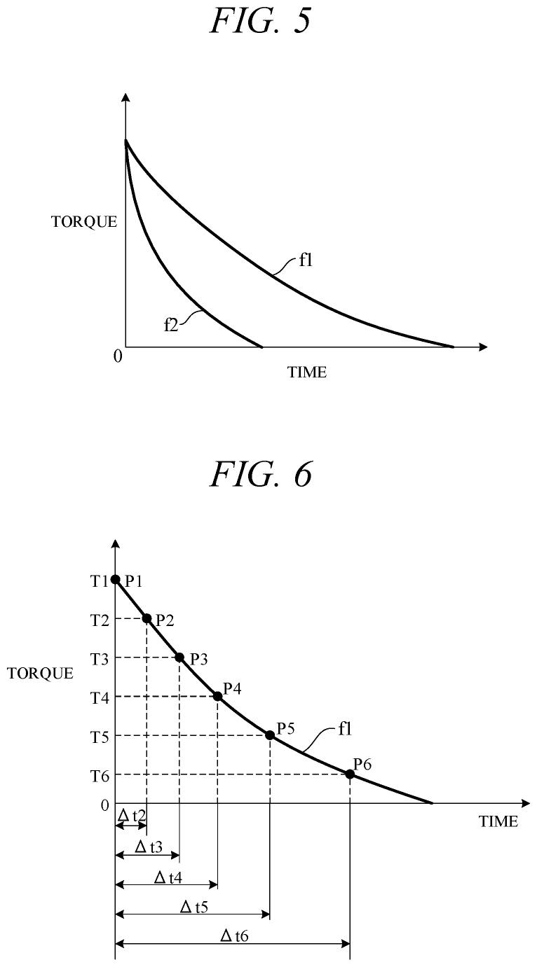

The characteristic setting unit 302 sets a fuel cut characteristic for determining the fuel cut timing, in accordance with the drive state of the vehicle. FIG. 5 is a diagram showing an example of fuel cut characteristics. Fuel cut characteristics are set so as to correspond to the shift positions of the transmission and are also set such that the torque is gradually reduced with time. More specifically, fuel cut characteristics are set such that the amount of reduction in the torque is gradually reduced with time from the initial value which is the output torque detected by the torque sensor 36 (the negative inclination is gradually reduced). For example, characteristics f1 and f2 in FIG. 5 are characteristics in different shift positions at a predetermined engine rotational speed, and the characteristic f1 is a characteristic in a lower shift position than that of the characteristic f2. That is, to reduce shock caused by fuel cut, fuel cut characteristics are set such that the torque is reduced more gently as the shift position is lower (as the speed ratio is greater).

Although not shown, fuel cut characteristics are set considering not only the shift position but also the engine rotational speed. That is, fuel cut characteristics are set such that, in the same shift position, the torque is reduced more gently as the engine rotational speed is lower. When the drive mode instructing unit 301 outputs a mode switch instruction to switch to the stop mode, the characteristic setting unit 302 sets a fuel cut characteristic on the basis of the output torque detected by the torque sensor 36. For example, the characteristic setting unit 302 selects a fuel cut characteristic corresponding to the current shift position and engine rotational speed from among multiple fuel cut characteristics previously stored in the storage unit of the controller 30 and sets this characteristic.

The order determination unit 303 determines the order of fuel cut of the cylinders. Specifically, the order determination unit 303 determines a cylinder to which the fuel is to be injected immediately after a stop mode instruction is output, as a cylinder on which fuel cut is to be performed first (the first cylinder). The order determination unit 303 then determines two cylinders belonging to the same group (bank) as that of the first cylinder, as a cylinder on which fuel cut is to be performed secondly (the second cylinder) and a cylinder on which fuel cut is to be performed thirdly (the third cylinder). The order determination unit 303 then determines three cylinders belonging to a group (bank) different from that of the first cylinder, as cylinders on which fuel cut is to be performed fourthly, fifthly, and sixthly (the fourth cylinder, fifth cylinder, and sixth cylinder).

For example, if the first cylinder is the front-bank cylinder [symbol] 1, the second and third cylinders are the front-bank cylinders [symbol] 2 and [symbol] 3 and the fourth, fifth, and sixth cylinders are the rear-bank cylinders [symbol] 4, [symbol] 5, and [symbol] 6. On the other hand, if the first cylinder is the rear-bank cylinder [symbol] 4, the second and third cylinders are the rear-bank cylinders [symbol] 5 and [symbol] 6 and the fourth, fifth, and sixth cylinders are the front-bank cylinders [symbol] 1, [symbol] 2, and [symbol] 3. That is, the order determination unit 303 determines the order of fuel cut of the cylinders such that the order of fuel cut of multiple cylinders in the same group becomes sequential order.

When the drive mode instructing unit 301 outputs a mode switch instruction to switch to the stop mode, the injector control unit 304 outputs control signals to the injectors 18 of the cylinders [symbol] 1 to [symbol] 6 to perform fuel cut on the cylinders [symbol] 1 to [symbol] 6. In this case, the injector control unit 304 first calculates the times from when fuel cut on the first cylinder is started until fuel cut is performed on the respective remaining cylinders (the second to sixth cylinders), that is, the fuel cut delay times of the respective cylinders in accordance with the fuel cut characteristic set by the characteristic setting unit 302. FIG. 6 is a diagram showing an example of the delay times calculated in accordance with the fuel cut characteristic f1. Note that the delay time Δt1 of the first cylinder is 0.

Specifically, as shown in FIG. 6, assuming that the engine output torque is reduced from the initial value T1 to T2, T3, T4, T5, T6, and 0 at equal intervals each time fuel cut is performed on one cylinder, the injector control unit 304 sets target points P1 to P6 corresponding to the torques T1 to T6 on the fuel cut characteristic f1 and calculates the times from the time point at which fuel cut is performed on the first cylinder (the target point P1) to the target points P2 to P6, as the respective delay times Δt2, Δt3, Δt4, Δt5, and Δt6 of the second, third, fourth, fifth, and sixth cylinders. The injector control unit 304 then counts the time elapsed since the fuel cut of the first cylinder. When the elapsed time reaches the delay times Δt2 to Δt6, the injector control unit 304 sequentially performs fuel cut on the second to sixth cylinders.

Before the drive mode instructing unit 301 outputs a mode switch instruction to switch to the stop mode, the injector control unit 304 controls the amount of injected fuel by outputting control signals to the injectors 18 so that the air fuel ratio becomes the stoichiometric air fuel ratio. That is, the injector control unit 304 performs AF feedback control on the basis of signals from the AF sensors 35. On the other hand, when the drive mode instructing unit 301 outputs a mode switch instruction to switch to the stop mode, the injector control unit 304 stops the AF feedback control over the bank on which fuel cut has been started. For example, if fuel cut on the front bank 1a is started first, the injector control unit 304 stops the AF feedback control over the front bank 1a and continues the AF feedback control over the rear bank 1b. Subsequently, when fuel cut on the rear bank 1b is started, the AF feedback control over the rear bank 1b is also stopped.

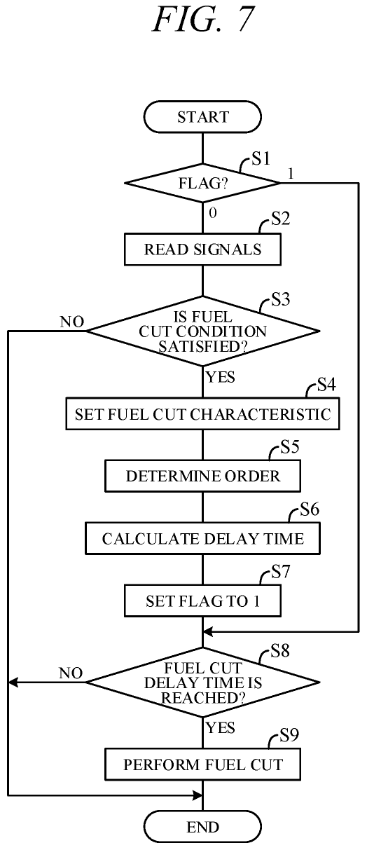

FIG. 7 is a flowchart showing an example of a process (a fuel cut process) performed by the CPU of the controller 30 in FIG. 4 in accordance with a program stored in memory in advance. The process shown by this flowchart is started, for example, when the engine 1 is operating in the normal mode. Subsequently, this process is repeated in a predetermined cycle until the change to the stop mode is complete, that is, until fuel cut on all the cylinders [symbol] 1 to [symbol] 6 is complete.

As shown in FIG. 7, first, in S1 (S means a process step), it is determined whether the flag is 0 or 1. In the initial state before the fuel cut condition is satisfied, the flag is 0. If it is determined in S1 that the flag is 0, the process proceeds to S2; if it is determined in S1 that the flag is 1, the process proceeds to S8. In S2, signals are read from the sensors 31 to 36. Then, in S3, it is determined whether the fuel cut condition is satisfied, on the basis of the signals from the sensors 31 to 33. If the determination in S3 is YES, the process proceeds to S4. If the determination in S3 is NO, the process ends. In this case, the amount of injected fuel is controlled (feedback control) so that the air fuel ratio detected by the AF sensors 35 becomes the stoichiometric air fuel ratio. On the other hand, in S4, a fuel cut characteristic having the output torque detected by the torque sensor 36 as the initial value is set on the basis of the current shift position detected by the shift position sensor 34 and the engine rotational speed detected by the rotational speed sensor 31.

Then, in S5, the order of fuel cut of the multiple cylinders [symbol] 1 to [symbol] 6 (the first to sixth cylinders) is determined. Specifically, a cylinder into which the fuel is to be injected immediately after the fuel cut condition is satisfied is determined as the first cylinder on which fuel cut is to be performed first; the remaining two cylinders in the same group as that of the first cylinder are determined as the second and third cylinders; and the three cylinders in the group different from that of the first cylinder are determined as the fourth to sixth cylinders. Then, in S6, the delay times Δt2 to Δt6 from when fuel cut on the first cylinder is started until fuel cut is performed on the second to sixth cylinders are calculated in accordance with the fuel cut characteristic set in S4. Then, in S7, the flag is set to 1.

Then, in S8, it is determined whether the fuel cut delay time of one of the cylinders [symbol] 1 to [symbol] 6 has been reached. If the determination in S8 is YES, the process proceeds to S9; if the determination in S8 is NO, the process ends. In S9, fuel cut is sequentially performed on the cylinders whose delay time has been determined to have been reached, ending the process. For the first cylinder, fuel cut is performed thereon with the delay time Δt1 of 0 (in other words, without setting the delay time) in S9. For the second to sixth cylinders, when the corresponding delay times Δt2 to Δt6 are determined to have been reached in S8 after the flag is set to 1, fuel cut is performed thereon in S9. When performing fuel cut, there is stopped AF feedback control over the bank to which the cylinder to be subjected to fuel cut belongs.

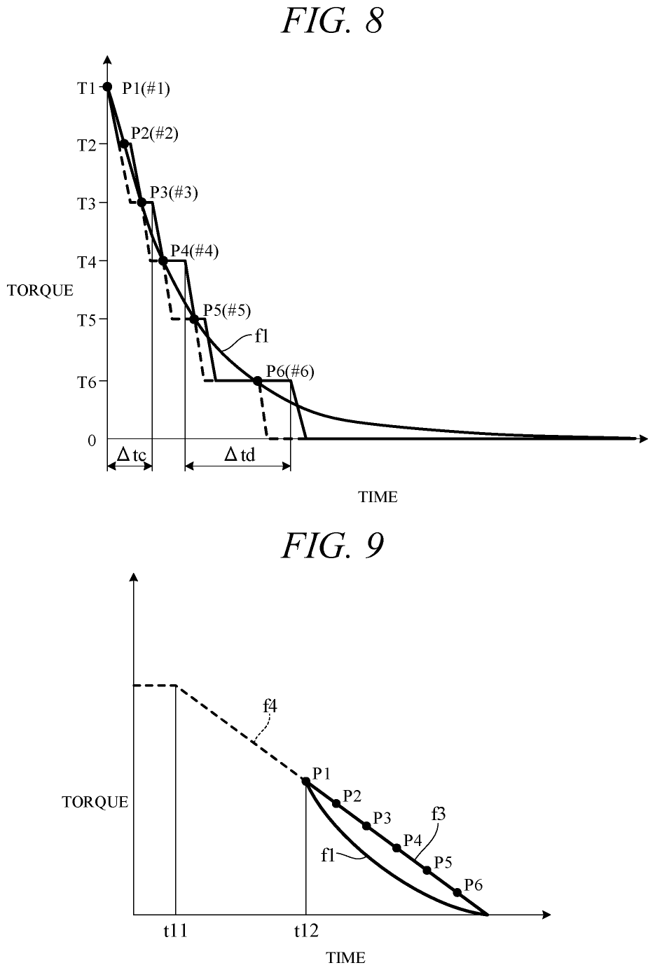

FIG. 8 is a diagram showing an example of the operation of the cylinder deactivation system 100 according to the present embodiment. The characteristic f1 in FIG. 8 is a fuel cut characteristic set by the characteristic setting unit 302. A characteristic shown by a stepwise solid line is a characteristic showing time-dependent torque reductions after outputting a mode switch instruction to switch to the stop mode. Note that a characteristic shown by a stepwise dotted line is a torque reduction characteristic shown when fuel cut is performed in accordance with the order of ignition of the cylinders [symbol] 1 to [symbol] 6. Specifically, in the characteristic shown by the dotted line, fuel cut is performed at the target points P1 to P6 in the order of [symbol] 4, [symbol] 1, [symbol] 5, [symbol] 2, [symbol] 3, and [symbol] 6.

In the example of FIG. 8, after having output the mode switch instruction to switch to the stop mode, first, fuel cut is performed on the front-bank cylinder [symbol] 1 at the target point P1. Then, fuel cut is performed on the remaining front-bank cylinders [symbol] 2 and [symbol] 3 at the target points P2 and P3. Then, fuel cut is sequentially performed on the rear-bank cylinders [symbol] 4, [symbol] 5, and [symbol] 6 at the target points P4, P5, and P6. Note that in FIG. 8, the torque reduction timings lag behind the fuel cut timings (the target points P2 to P6). This is because there are time lags between fuel cut and the subsequent operation of the cylinders [symbol] 2 to [symbol] 6.

The cylinder deactivation system 100 according to the present embodiment sequentially performs fuel cut on the multiple cylinders [symbol] 1 to [symbol] 6 on a bank basis. Thus, the cylinder deactivation system 100 is able to reduce the time Δtc from when fuel cut on one (e.g., [symbol] 1) of the front-bank cylinders [symbol] 1 to [symbol] 3 is started until fuel cut on the three cylinders ( [symbol] 1 to [symbol] 3) is complete and the time Δtd from when fuel cut on one (e.g., [symbol] 4) of the rear-bank cylinders [symbol] 4 to [symbol] 6 is started until fuel cut on the three cylinders ( [symbol] 4 to [symbol] 6) is complete. As a result, the cylinder deactivation system 100 is able to confine the respective lean-state times Δtc and Δtd of the banks 1a and 1b within the leanness allowable time Δta of the catalyst devices 23 and 24 and thus to reliably prevent emission deterioration.

The cylinder deactivation system 100 according to the present embodiment is able to achieve advantages and effects such as the following.

(1) The cylinder deactivation system 100 includes the engine 1 that includes the multiple cylinders [symbol] 1 to [symbol] 6 including the multiple front-bank cylinders [symbol] 1 to [symbol] 3 belonging to the one bank 1a and the multiple rear-bank cylinder cylinders [symbol] 4 to [symbol] 6 belonging to the other bank 1b, the catalyst devices 23 and 24 disposed in the exhaust passage 141 of the cylinders of the bank 1a and the exhaust passage 142 of the cylinders of the bank 1b, the injectors 18 that individually supply the fuel to the cylinders [symbol] 1 to [symbol] 6, the drive mode instructing unit 301 that outputs a mode switch instruction to switch from the normal mode in which the fuel is supplied to the cylinders [symbol] 1 to [symbol] 6 and the stop mode in which fuel supply to the cylinders [symbol] 1 to [symbol] 6 is stopped, and the controller 30 that when the drive mode instructing unit 301 outputs a mode switch instruction to switch from the normal mode to the stop mode, controls the injectors 18 so that fuel supply to the cylinders [symbol] 1 to [symbol] 6 is stopped in stages (FIGS. 1 and 4). The controller 30 controls the injectors 18 so that fuel supply to the front-bank cylinders [symbol] 1 to [symbol] 3 is stopped and then fuel supply to the rear-bank cylinders [symbol] 4 to [symbol] 6 is stopped or so that fuel supply to the rear-bank cylinders [symbol] 4 to [symbol] 6 is stopped and then fuel supply to the front-bank cylinders [symbol] 1 to [symbol] 3 is stopped.

As seen above, when sequentially performing fuel cut on the cylinders [symbol] 1 to [symbol] 6, the cylinder deactivation system 100 sequentially performs fuel cut on each of the front-bank cylinders [symbol] 1 to [symbol] 3 and the rear-bank cylinders [symbol] 4 to [symbol] 6. Thus, the cylinder deactivation system 100 is able to reduce the time Δtc from when fuel cut on one cylinder of the front bank 1a is started until fuel cut on the three cylinders thereof is complete and the time Δtd from when fuel cut on one cylinder of the rear bank 1b is started until fuel cut on the three cylinders thereof is complete. As a result, the cylinder deactivation system 100 is able to confine the respective lean-state times Δtc and Δtd of the banks 1a and 1b with the leanness allowable time Δta of the catalyst devices 23 and 24 and thus to reliably prevent emission deterioration while suppressing shock caused by torque reductions during fuel cut.

(2) The cylinder deactivation system 100 also includes the characteristic setting unit 302 that sets a fuel cut characteristic in which the engine output torque is gradually reduced with time (FIG. 4). The controller 30 controls the injectors 18 so that fuel supply to the cylinders [symbol] 1 to [symbol] 6 is sequentially stopped, in accordance with the characteristic (e.g., the characteristic f1) set by the characteristic setting unit 302 (FIG. 8). Thus, the cylinder deactivation system 100 is able to perform fuel cut on the cylinders [symbol] 1 to [symbol] 6 in stages at the optimum timings such that shock caused by torque reductions is reduced.
(3) The characteristic setting unit 302 sets the multiple fuel cut characteristics f1 and f2 in accordance with the shift positions (speed ratios) of the transmission configured to change rotation speed input from the engine 1 and to output the resulting rotation speed (FIG. 5). Although the magnitude of shock caused by fuel cut varies with the speed ratio, the cylinder deactivation system 100 according to the present embodiment determines the fuel cut timing in accordance with a characteristic corresponding to the speed ratio and thus is able to perform fuel cut at the optimum timings.
(4) The cylinder deactivation system 100 also includes the AF sensors 35 that detect the emission air fuel ratio. Before the drive mode instructing unit 301 outputs a mode switch instruction to switch from the normal mode to the stop mode, the injector control unit 304 controls the injectors 18 by AF feedback control so that the air fuel ratios detected by the AF sensors 35 become the predetermined air fuel ratio (e.g., the stoichiometric air fuel ratio). When the drive mode instructing unit 301 outputs a mode switch instruction to switch to the stop mode, the injector control unit 304 controls the injectors 18 so that a processing to stop of fuel supply to the front-bank cylinders [symbol] 1 to [symbol] 3 is started; AF feedback control over the front-bank cylinders [symbol] 1 to [symbol] 3 is stopped until the processing is complete; and AF feedback control over the rear-bank cylinders [symbol] 4 to [symbol] 6 is continued. As seen above, the injector control unit 304 stops AF feedback control over the bank on which fuel cut has been started and thus is able to prevent the amount of injected fuel from being excessively corrected to the rich side.

Fuel cut characteristics set by the characteristic setting unit 302 are not limited to the above-mentioned characteristics f1 and f2. FIG. 9 is a diagram showing an example of another fuel cut characteristic f3. FIG. 9 also shows, by a dotted line, a characteristic f4 showing changes in the output torque in the period from when the accelerator pedal is released (time point t11) until fuel cut is started (time point t12), which is a characteristic immediately before fuel cut is started. There is a delay time between when the accelerator pedal is released (t11) and when fuel cut is started (t12). The reasons include that there is a delay in reducing the amount of intake air of the engine 1, that is, air intake into the engine 1 is behind the operation of the throttle valve 19; the ignition timing is retarded in ignition control, that is, a delay is caused in the ignition timing retarding process; and the like. Although multiple characteristics f3 are set in accordance with the shift position and the engine rotational speed as described above, FIG. 9 shows only one characteristic (solid line) corresponding to the above-mentioned characteristic f1.

As shown in FIG. 9, after the accelerator pedal is released (after time point t11), the output torque is linearly reduced (a characteristic f4). The characteristic setting unit 302 calculates the inclination of the characteristic f4 on the basis of a signal from the torque sensor 36 and sets the fuel cut characteristic f3 in accordance with the calculated inclination of the characteristic f4. That is, the characteristic setting unit 302 sets the fuel cut characteristic f3 such that it becomes a characteristic having a constant inclination matching the inclination of the characteristic f4. Thus, the torque is reduced at a constant rate before and after fuel cut is started (before and after time point t12), allowing for a further reduction in shock caused by fuel cut.

The above-mentioned embodiment can be modified into various forms. Hereafter, modifications will be described. While, in the above embodiment, a V-6 engine having a pair of front and rear banks is use as an example of an internal combustion engine, other internal combustions such as an engine horizontally opposed engine may be used as an example of an internal combustion engine as long as the other internal combustion have a plurality of (a first group and second group). While, in the above embodiment, the front-bank cylinders and the rear-bank cylinders respectively are configured of three cylinders, the number of cylinders of a first group and a second group cylinders may be otherwise.

While, in the above embodiment, the catalyst device (first catalyst device) 23 and the catalyst device (second catalyst device) 24 are respectively disposed in the exhaust passage 141 connected to the front bank 1a and the exhaust passage 142 connected to the rear bank 1b, a pair of catalyst devices may be disposed otherwise as long as the pair of catalyst devices disposed in exhaust passages of a first group and exhaust passages of a second group. A pair of catalyst devices may be configured otherwise as long as the pair of catalyst devices have an oxygen storage capacity and also have a reduction function. While, in the above embodiment, the direct-injection injector 18 is used in each of the cylinders [symbol] 1 to [symbol] 6, a fuel supply part may be configured otherwise as long as the fuel supply part individually supplies fuel to each of a plurality of cylinders.

While, in the above embodiment, the drive mode instructing unit 301 output the mode switch instruction from the normal mode (first mode) to the stop mode (second mode) on the basis of sensors 31 to 33, a drive mode instructing unit may be configured otherwise. The controller 30 as a controller may be configured otherwise as long as the controller controls a fuel supply part such as the injector 18 so as to stop a fuel supply to a plurality of second group cylinders (e.g., the rear-bank cylinders [symbol] 4 to [symbol] 6) after stopping a fuel supply to a plurality of first group cylinders (e.g., the front-bank cylinders [symbol] 1 to [symbol] 3) when performing a fuel cut is instructed. Further, a fuel cut can be performed without setting a fuel cut characteristic by the characteristic setting unit 302 (a setting unit). While, in the above embodiment, the emission air fuel ratio is detected by the AF sensors 35 detects, an air fuel ratio detection part may be configured otherwise.

The present invention can be used as a cylinder deactivation method of an internal combustion engine in a cylinder deactivation system in which the internal combustion engine includes a plurality of cylinders having a plurality of first group cylinders belonging to a first group and a plurality of second group cylinders belonging to a second group, a fuel supply part is configured to individually supply a fuel to each of the plurality of cylinders, and a first catalyst device and a second catalyst device are disposed respectively in an exhaust passage of the first group and an exhaust passage of the second group.

The above embodiment can be combined as desired with one or more of the above modifications. The modifications can also be combined with one another.

According to the present invention, it is possible to sufficiently obtain effect of cleaning up emissions by a catalyst device even if fuel supply is stopped in stages in a system in which a catalyst device is individually disposed in each of a plurality of exhaust passages connected to an engine.

Above, while the present invention has been described with reference to the preferred embodiments thereof, it will be understood, by those skilled in the art, that various changes and modifications may be made thereto without departing from the scope of the appended claims.

What is claimed is:

1. A cylinder deactivation system comprising:
an internal combustion engine including a plurality of cylinders having a plurality of first group cylinders belonging to a first group and a plurality of second group cylinders belonging to a second group;
a first catalyst device and a second catalyst device respectively disposed in an exhaust passage of the first group and an exhaust passage of the second group;
a fuel supply part configured to individually supply a fuel to each of the plurality of cylinders; and
an electronic control unit having a microprocessor and a memory connected to the microprocessor, wherein
the microprocessor is configured to perform:
outputting a mode switch instruction from a first mode in which a fuel supply to the plurality of cylinders is performed to a second mode in which the fuel supply to the plurality of cylinders is stopped; and
when the mode switch instruction is output, controlling the fuel supply part so as to stop the fuel supply to the plurality of cylinders in stages, and wherein
the microprocessor is configured to perform
the controlling including controlling the fuel supply part so as to stop a fuel supply to the plurality of second group cylinders after a fuel supply to the plurality of first group cylinders is stop.

2. The cylinder deactivation system according to claim 1, wherein
the microprocessor is further configured to perform setting a characteristic in which an output torque of the internal combustion engine is gradually reduced with time, and wherein
the microprocessor is configured to perform
the controlling including controlling the fuel supply part so as to the fuel supply to the plurality of cylinders is stopped in stages in accordance with the characteristic set in the setting.

3. The cylinder deactivation system according to claim 2, wherein
the microprocessor is configured to perform
the setting including setting a plurality of the characteristics in accordance with a speed ratio of a transmission configured to change and output a rotation speed input from the internal combustion engine.

4. The cylinder deactivation system according to claim 2, wherein
the microprocessor is configured to perform the setting including setting a plurality of the characteristics in accordance with a number of rotations of the internal combustion engine.

5. The cylinder deactivation system according to claim 2, wherein
the microprocessor is configured to perform the setting including setting the characteristics so that an output torque of the internal combustion engine is reduced at a constant rate with time.

6. The cylinder deactivation system according to claim 5, wherein
the microprocessor is configured to perform the setting including calculating an inclination of reduction of an output torque of the internal combustion engine at the time immediately before the mode switch instruction is output and setting an inclination of the characteristic correspondent to the inclination calculated in the calculating.

7. The cylinder deactivation system according to claim 1 further comprising
an air fuel ratio detection part configured to detect an air fuel ratio of an emission, wherein
the microprocessor is configured to perform the controlling including:
controlling the fuel supply part with a feedback control so that the air fuel ratio detected by the air fuel ratio detection part becomes a predetermined air fuel ratio before the mode switch instruction from the first mode to the second mode is output; and
when the mode switch instruction from the first mode to the second mode is output, controlling the fuel supply part so as to stop a feedback control to the plurality of first group cylinders and continue a feedback control to the plurality of second group cylinders before a processing to stop the fuel supply to the plurality of first group cylinders is started and the processing is completed.

8. A cylinder deactivation system comprising:
an internal combustion engine including a plurality of cylinders having a plurality of first group cylinders belonging to a first group and a plurality of second group cylinders belonging to a second group;
a first catalyst device and a second catalyst device respectively disposing on an exhaust passage of the first group and an exhaust passage of the second group;
and a fuel supply part configured to individually supply a fuel to each of the plurality of cylinders; and
an electronic control unit having a microprocessor and a memory connected to the microprocessor, wherein
the microprocessor is configured to function as
an instructing unit configured to output a mode switch instruction from a first mode in which a fuel supply to the plurality of cylinders is performed to a second mode in which the fuel supply to the plurality of cylinders is stopped, and
controller configured to, when the mode switch instruction is output, control the fuel supply part so as to stop the fuel supply to the plurality of cylinders in stages, and wherein
the microprocessor is configured to function as
the controller controls the fuel supply part so as to stop a fuel supply to the plurality of second group cylinders after a fuel supply to the plurality of first group cylinders is stop.

9. The cylinder deactivation system according to claim 8, wherein
the microprocessor is further configured to function as
a setting unit configured to set a characteristic in which an output torque of the internal combustion engine is gradually reduced with time, and wherein
the microprocessor is configured to function as
the controller configured to control the fuel supply part so as to the fuel supply to the plurality of cylinders is stopped in stages in accordance with the characteristic set in the setting.

10. The cylinder deactivation system according to claim 9, wherein
the microprocessor is configured to function as
the setting unit configured to set a plurality of the characteristics in accordance with a speed ratio of a transmission configured to change and output a rotation speed input from the internal combustion engine.

11. The cylinder deactivation system according to claim 9, wherein
the microprocessor is configured to function as
the setting unit configured to set a plurality of the characteristics in accordance with a number of rotations of the internal combustion engine.

12. The cylinder deactivation system according to claim 9 wherein
the microprocessor is configured to function as
the setting unit configured to set the characteristics so that an output torque of the internal combustion engine is reduced at a constant rate with time.

13. The cylinder deactivation system according to claim 12, wherein
the microprocessor is configured to function as
the setting unit configured to calculate an inclination of reduction of an output torque of the internal combustion engine at the time immediately before the mode switch instruction is output and set an inclination of the characteristic correspondent to the inclination calculated in the calculating.

14. The cylinder deactivation system according to claim 8 further comprising
an air fuel ratio detection part configured to detect an air fuel ratio of an emission, wherein
the microprocessor is configured to function as:
the controller configured to control the fuel supply part with a feedback control so that the air fuel ratio detected by the air fuel ratio detection part becomes a predetermined air fuel ratio before the mode switch instruction from the first mode to the second mode is output; and
when the mode switch instruction from the first mode to the second mode is output, control the fuel supply part so as to stop a feedback control to the plurality of first group cylinders and continue a feedback control to the plurality of second group cylinders before a processing to stop the fuel supply to the plurality of first group cylinders is started and the processing is completed.

15. A cylinder deactivation method of an internal combustion engine, the internal combustion engine including a plurality of cylinders having a plurality of first group cylinders belonging to a first group and a plurality of second group cylinders belonging to a second group, a first catalyst device and a second catalyst device being disposed respectively in an exhaust passage of the first group and an exhaust passage of the second group, a fuel supply part being configured to individually supply a fuel to each of the plurality of cylinders,
the cylinder deactivation method comprising:
outputting a mode switch instruction from a first mode in which a fuel supply to the plurality of cylinders is performed to a second mode in which the fuel supply to the plurality of cylinders is stopped; and
when the instruction is output, controlling the fuel supply part so that the fuel supply to the plurality of cylinders is stopped in stages, wherein
the controlling includes controlling the fuel supply part so that a fuel supply to the plurality of second group cylinders is stop after a fuel supply to the plurality of first group cylinders is stop.
